(19) United States
(12) Patent Application Publication
(10) Pub. No.: US 2024/0274137 A1
(43) Pub. Date: Aug. 15, 2024

(54) PARAMETRIC SPATIAL AUDIO RENDERING

(71) Applicant: NOKIA TECHNOLOGIES OY, Espoo (FI)

(72) Inventors: Mikko-Ville LAITINEN, Espoo (FI); Juha Tapio VILKAMO, Helsinki (FI); Lasse Juhani LAAKSONEN, Tampere (FI); Anssi Sakari RÄMÖ, Tampere (FI)

(73) Assignee: NOKIA TECHNOLOGIES OY, Espoo (FI)

(21) Appl. No.: 18/568,526

(22) PCT Filed: Jun. 10, 2021
(86) PCT No.: PCT/FI2021/050434

§ 371 Date: Dec. 8, 2023

(51) Int. Cl. G10L 19/008; H04S 3/00

(52) U.S. Cl. CPC G10L 19/008; H04S 3/008; H04S 2420/03

(57) ABSTRACT

An apparatus (317) comprising means configured to: receive a spatial audio signal, the spatial audio signal comprising at least one audio signal and spatial metadata (122) associated with the at least one audio signal; generate a mixing value (320) based on the spatial metadata (122) and a predefined parameter (322) which imparts effects of a rendering of a multichannel audio signal having a multichannel configuration to a further multichannel audio signal having a further multichannel configuration on generated output signals; and generating the output audio signals having the further multichannel configuration based on the mixing value (320) and the spatial audio signal.

### FIELD

The present application relates to apparatus and methods for spatial audio representation and rendering, but not exclusively for audio representation for an audio decoder.

### BACKGROUND

Immersive audio codecs are being implemented supporting a multitude of operating points ranging from a low bit rate operation to transparency. An example of such a codec is the Immersive Voice and Audio Services (IVAS) codec which is being designed to be suitable for use over a communications network such as a 3GPP 4G/5G network including use in such immersive services as for example immersive voice and audio for virtual reality (VR). This audio codec is expected to handle the encoding, decoding and rendering of speech, music and generic audio. It is furthermore expected to support channel-based audio and scene-based audio inputs including spatial information about the sound field and sound sources. The codec is also expected to operate with low latency to enable conversational services as well as support high error robustness under various transmission conditions.

Input signals can be presented to the IVAS encoder in one of a number of supported formats (and in some allowed combinations of the formats). For example, a mono audio signal (without metadata) may be encoded using an Enhanced Voice Service (EVS) encoder, which may be embedded within the core of the IVAS encoder. Other input formats may utilize new IVAS encoding tools. One input format proposed for IVAS is the Metadata-assisted spatial audio (MASA) format, where the encoder may utilize, e.g., a combination of mono and stereo encoding tools and metadata encoding tools for efficient transmission of the format. MASA is a parametric spatial audio format suitable for spatial audio processing. Parametric spatial audio processing is a field of audio signal processing where the spatial aspect of the sound (or sound scene) is described using a set of parameters. For example, in parametric spatial audio capture from microphone arrays, it is a typical and an effective choice to estimate from the microphone array signals a set of parameters such as directions of the sound in frequency bands, and the relative energies of the directional and non-directional parts of the captured sound in frequency bands, expressed for example as a direct-to-total ratio or an ambient-to-total energy ratio in frequency bands. These parameters are known to well describe the perceptual spatial properties of the captured sound at the position of the microphone array. These parameters can be utilized in synthesis of the spatial sound accordingly, for headphones binaurally, for loudspeakers, or to other formats, such as Ambisonics.

For example, there can be two channels (stereo) of audio signals and spatial metadata. The spatial metadata may furthermore define parameters such as: Direction index, describing a direction of arrival of the sound at a time-frequency parameter interval; level/phase differences; Direct-to-total energy ratio, describing an energy ratio for the direction index; Diffuseness; Coherences such as Spread coherence describing a spread of energy for the direction index; Diffuse-to-total energy ratio, describing an energy ratio of non-directional sound over surrounding directions; Surround coherence describing a coherence of the non-directional sound over the surrounding directions; Remainder-to-total energy ratio, describing an energy ratio of the remainder (such as microphone noise) sound energy to fulfil requirement that sum of energy ratios is 1; Distance, describing a distance of the sound originating from the direction index in meters on a logarithmic scale; covariance matrices related to a multi-channel loudspeaker signal, or any data related to these covariance matrices; other parameters guiding a specific decoder, e.g., centre prediction coefficients and one-to-two decoding coefficients (used, e.g., in MPEG Surround). Any of these parameters can be determined in frequency bands.

### SUMMARY

There is provided according to a first aspect an apparatus comprising means for receiving a spatial audio signal, the spatial audio signal comprising at least one audio signal and spatial metadata associated with the at least one audio signal; generating a mixing value based on the spatial metadata and a predefined parameter which imparts effects of a rendering of a multichannel audio signal having a multichannel configuration to a further multichannel audio signal having a further multichannel configuration on generated output signals, wherein the multichannel configuration is indicated by a loudspeaker configuration parameter; and generating the output audio signals having the further multichannel configuration based on the mixing value and the spatial audio signal.

The apparatus comprising means for generating the mixing value based on the spatial metadata and the predefined parameter may comprise means for: generating a direct sound value for each channel of the multichannel configuration based on a spatial sound direction parameter, a spatial sound energy ratio parameter and the multichannel configuration, wherein the spatial metadata comprises the spatial sound direction parameter and the spatial sound energy ratio parameter; and generating an ambient sound value for each channel of the multichannel configuration based on the spatial sound energy ratio parameter and the multichannel configuration.

The apparatus comprising means for generating a direct sound value for each channel of the multichannel configuration based on the spatial sound direction parameter, the spatial sound energy ratio parameter and the multichannel configuration may comprise means for: generating a panning gain value for each channel based on amplitude panning and the spatial sound direction parameter; and generating the direct sound value for each channel by multiplying the panning gain value by the spatial sound energy ratio parameter.

The apparatus comprising means for generating the ambient sound value for each channel of the multichannel configuration based on the spatial sound energy ratio parameter and the multichannel configuration may comprise means for: determining the ambient sound value for each channel as the ratio of one minus the spatial audio energy ratio parameter to the number of channels of the multichannel configuration.

The apparatus comprising means for generating the mixing value based on the spatial metadata and the predefined parameter which imparts the effects of the rendering of the multichannel audio signal having the multichannel configuration to the further multichannel audio signal having the further multichannel configuration on the generated output signals may comprise means for: multiplying the direct sound value and the ambient sound value for each channel of the multichannel configuration with a corresponding channel gain, wherein the corresponding channel gain is derived, for the each channel, from the predefined parameter.

The predefined parameter which imparts the effects of the rendering of the multichannel audio signal having the multichannel configuration to the further multichannel audio signal having the further multichannel configuration on the generated output signals may comprise a predefined matrix whose components are gain terms derived for the mixing of a multichannel audio signal whose configuration is the multichannel configuration to the further multichannel audio signal whose configuration is the further multichannel configuration, wherein each column or row of the predefined matrix corresponds to a channel of the further multichannel audio signal. In this case the corresponding channel gain may be determined by summing components of a corresponding column or row of the predefined matrix.

The predefined parameter which imparts the effect of the rendering of the multichannel audio signal having the multichannel configuration to the further multichannel audio signal having the further multichannel configuration on the generated output signals may comprise a vector of channel gains, where each component of the vector of channel gains comprises a channel gain determined by summing terms of a column or a row of a predefined matrix, wherein the predefined matrix whose components are gain terms derived for the mixing of a multichannel audio signal whose configuration is the multichannel configuration to the further multichannel audio signal whose configuration is the further multichannel configuration, wherein each column or row of the predefined matrix corresponds to a channel of the further multichannel audio signal. In this case the corresponding channel gain may be determined as a channel gain from the vector of channel gains.

The multichannel configuration may be a 5.0 channel configuration and wherein the further channel configuration is a stereo channel. In which the predefined parameter may comprise a first column or row vector of the gain terms [1, 0, 0.7, 0.7, 0] and a second column vector or row of the gain terms [0, 1, 0.7, 0, 0.7].

Alternatively, when the multichannel configuration is a 5.1 channel configuration and wherein the further channel configuration is a stereo channel. In which case the predefined parameter may comprise a first column or row vector of the gain terms [1, 0, 0.7, 0.7, 0.7, 0] and a second column or row vector of the gain terms [0, 1, 0.7, 0.7, 0, 0.7].

The spatial audio energy ratio parameter may be a direct to total energy ratio, and wherein the spatial audio direction parameter may comprise an elevation value and an azimuth value.

According to a second aspect there is provided a method comprising: receiving a spatial audio signal, the spatial audio signal comprising at least one audio signal and spatial metadata associated with the at least one audio signal; generating a mixing value based on the spatial metadata and a predefined parameter which imparts effects of a rendering of a multichannel audio signal having a multichannel configuration to a further multichannel audio signal having a further multichannel configuration on generated output signals, wherein the multichannel configuration is indicated by a loudspeaker configuration parameter; and generating the output audio signals having the further multichannel configuration based on the mixing value and the spatial audio signal.

The method comprising generating the mixing value based on the spatial metadata and the predefined parameter may comprise: generating a direct sound value for each channel of the multichannel configuration based on a spatial sound direction parameter, a spatial sound energy ratio parameter and the multichannel configuration, wherein the spatial metadata comprises the spatial sound direction parameter and the spatial sound energy ratio parameter; and generating an ambient sound value for each channel of the multichannel configuration based on the spatial sound energy ratio parameter and the multichannel configuration.

The method comprising generating a direct sound value for each channel of the multichannel configuration based on the spatial sound direction parameter, the spatial sound energy ratio parameter and the multichannel configuration may comprise: generating a panning gain value for each channel based on amplitude panning and the spatial sound direction parameter; and generating the direct sound value for each channel by multiplying the panning gain value by the spatial sound energy ratio parameter.

The method comprising generating the ambient sound value for each channel of the multichannel configuration based on the spatial sound energy ratio parameter and the multichannel configuration may comprise: determining the ambient sound value for each channel as the ratio of one minus the spatial audio energy ratio parameter to the number of channels of the multichannel configuration.

The method comprising generating the mixing value based on the spatial metadata and the predefined parameter which imparts the effects of the rendering of the multichannel audio signal having the multichannel configuration to the further multichannel audio signal having the further multichannel configuration on the generated output signals may comprise: multiplying the direct sound value and the ambient sound value for each channel of the multichannel configuration with a corresponding channel gain, wherein the corresponding channel gain is derived, for the each channel, from the predefined parameter.

The predefined parameter which imparts the effects of the rendering of the multichannel audio signal having the multichannel configuration to the further multichannel audio signal having the further multichannel configuration on the generated output signals may comprise a predefined matrix whose components are gain terms derived for the mixing of a multichannel audio signal whose configuration is the multichannel configuration to the further multichannel audio signal whose configuration is the further multichannel configuration, wherein each column or row of the predefined matrix corresponds to a channel of the further multichannel audio signal. In this case the corresponding channel gain may be determined by summing components of a corresponding column or row of the predefined matrix.

The predefined parameter which imparts the effect of the rendering of the multichannel audio signal having the multichannel configuration to the further multichannel audio signal having the further multichannel configuration on the generated output signals may comprise a vector of channel gains, where each component of the vector of channel gains comprises a channel gain determined by summing terms of a column or a row of a predefined matrix, wherein the predefined matrix whose components are gain terms derived for the mixing of a multichannel audio signal whose configuration is the multichannel configuration to the further multichannel audio signal whose configuration is the further multichannel configuration, wherein each column or row of the predefined matrix corresponds to a channel of the further multichannel audio signal. In this case the corresponding channel gain may be determined as a channel gain from the vector of channel gains.

The multichannel configuration may be a 5.0 channel configuration and wherein the further channel configuration is a stereo channel. In which the predefined parameter may comprise a first column or row vector of the gain terms [1, 0, 0.7, 0.7, 0] and a second column vector or row of the gain terms [0, 1, 0.7, 0, 0.7].

Alternatively, when the multichannel configuration is a 5.1 channel configuration and wherein the further channel configuration is a stereo channel. In which case the predefined parameter may comprise a first column or row vector of the gain terms [1, 0, 0.7, 0.7, 0.7, 0] and a second column or row vector of the gain terms [0, 1, 0.7, 0.7, 0, 0.7].

The spatial audio energy ratio parameter may be a direct to total energy ratio, and wherein the spatial audio direction parameter may comprise an elevation value and an azimuth value.

According to a third aspect there is provided an apparatus comprising at least one processor and at least one memory including a computer program code, the at least one memory and the computer program code configured to, with the at least one processor, cause the apparatus at least to: receive a spatial audio signal, the spatial audio signal comprising at least one audio signal and spatial metadata associated with the at least one audio signal; generate a mixing value based on the spatial metadata and a predefined parameter which imparts effects of a rendering of a multichannel audio signal having a multichannel configuration to a further multichannel audio signal having a further multichannel configuration on generated output signals, wherein the multichannel configuration is indicated by a loudspeaker configuration parameter; and generate the output audio signals having the further multichannel configuration based on the mixing value and the spatial audio signal.

According to a fourth aspect there is provided a computer program comprising instructions for causing an apparatus to perform at least the following: receiving a spatial audio signal, the spatial audio signal comprising at least one audio signal and spatial metadata associated with the at least one audio signal; generating a mixing value based on the spatial metadata and a predefined parameter which imparts effects of a rendering of a multichannel audio signal having a multichannel configuration to a further multichannel audio signal having a further multichannel configuration on generated output signals, wherein the multichannel configuration is indicated by a loudspeaker configuration parameter; and generating the output audio signals having the further multichannel configuration based on the mixing value and the spatial audio signal.

According to a fifth aspect there is provided a non-transitory computer readable medium comprising program instructions for causing an apparatus to perform at least the following: receiving a spatial audio signal, the spatial audio signal comprising at least one audio signal and spatial metadata associated with the at least one audio signal; generating a mixing value based on the spatial metadata and a predefined parameter which imparts effects of a rendering of a multichannel audio signal having a multichannel configuration to a further multichannel audio signal having a further multichannel configuration on generated output signals, wherein the multichannel configuration is indicated by a loudspeaker configuration parameter; and generating the output audio signals having the further multichannel configuration based on the mixing value and the spatial audio signal.

An apparatus configured to perform the actions of the method as described above.

A computer program comprising program instructions for causing a computer to perform the method as described above.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIG. 1 shows schematically a system of apparatus suitable for implementing some embodiments;

FIG. 2 shows a flow diagram of the operation of the example apparatus according to some embodiments;

FIG. 3 shows schematically an example synthesis processor as shown in FIG. 1 according to some embodiments;

FIG. 4 shows a flow diagram of the operation of the example synthesis processor as shown in FIG. 3 according to some embodiments;

FIG. 5 shows schematically an example gains determiner as shown in FIG. 3;

FIG. 6 shows schematically an example spatial synthesizer as shown in FIG. 3 according to some embodiments;

FIG. 7 shows a flow diagram of the operation of the example spatial synthesizer as shown in FIG. 6 according to some embodiments;

FIG. 8 shows a flow diagram of the operation of the example gains determiner as shown in FIG. 5; and

FIG. 9 shows an example device suitable for implementing the apparatus shown in previous figures.

### EMBODIMENTS OF THE APPLICATION

The term audio signal as used herein may refer to a single audio channel, or an audio signal with two or more channels. For instance, an example of a multichannel input audio signal may be a 5.1 multichannel audio signal comprising a left, right, centre, LFE, side left and side right channels. When encoding using IVAS a multichannel audio signal may be downmixed to two audio signal channels (which may be termed transport audio signals so called because the two audio signals are mainly formed for the purpose of storage or transport) and then encoded using an EVS encoder (or other suitable audio codec). The encoded audio transport signals along with the encoded parametric spatial audio data (MASA data) may be either stored for later use by a decoder or transmitted to decoder for decoding. At an IVAS decoder the decoded audio transport audio signals may then be rendered with the aid of the decoded parametric spatial audio parameters to a multichannel audio signal, one such example may be a stereo audio for playback via loudspeakers. However, the decoded audio transport signals may be rendered to other multichannel audio signal formats such as 5.1.

In general, downmixing of a multichannel audio signal may be typically performed using a predefined matrix. For example a 5.1 multichannel audio signal may be down mixed to a stereo audio signal using the following predefined matrix for the left channel [1, 0, 0.7, 0.7, 0.7, 0] and the following predefined matrix for the right channel [0, 1, 0.7, 0.7, 0, 0.7]. In practice, downmixing to a stereo signal with the above predefined matrix results in the original left, right, centre, and LFE channels being downmixed to a constant energy, and the side right and left channels being downmixed to a decrease in energy of 3 dB. It is therefore desirable to replicate this downmixing result when rendering at the decoder of an IVAS coding system.

However, in an IVAS type coding system the problem arises when the transport audio signals are rendered at the decoder into a stereo signal using the accompanying parametric audio/MASA parameters. Ideally, the resulting perceived stereo signal should reflect the 3 dB decrease of energy in the side channels as obtained using the predefined matrix. However, known rendering and downmixing techniques at the decoder fail to take into account the above desired effect of the predefined matrix as described above. This results in the unwanted effect of the side channels being perceived as having equal loudness to the original side channels within the rendered stereo audio signal.

One solution to the above problem would be to render the transport audio signals and MASA stream into the multichannel audio signal at the decoder and then apply the predefined downmix matrix to obtain the two audio channels (stereo channels). However, this approach would require considerable processing. For example, in the scenario of a 5.1 multichannel the two channels of the transport audio stream would be required to render up to six audio channels, and then downmix the resulting six channels back down to a stereo pair. In addition to the considerable processing requirement, this approach has a further disadvantage needing to introduce incoherent channel components when rendering from the two channel transport audio signals to the multichannel audio signals. It is known that in some circumstances the decorrelation techniques can actually deteriorate the overall audio experience. For example, Vilkamo, J. and Pulkki, V., 2013, “Minimization of decorrelator artifacts in directional audio coding by covariance domain rendering”, Journal of the Audio Engineering Society, 61(9), pp. 637-646 shows a listening test involving two different means to render spatial sound, where the first method was the one defined earlier in Vilkamo, J., Bäckström, T. and Kuntz, A., 2013, “Optimized covariance domain framework for time-frequency processing of spatial audio”, Journal of the Audio Engineering Society, 61(6), pp. 403-411 and a second method was a prior method not optimizing the amount of the applied decorrelated sound energy. The effective difference of these methods is primarily the relative amount of decorrelated sound energy, as the first method utilizes the existing independent signals at the input more effectively. The listening test provided results of perceived quality for the two methods for different sound scenes. From the results it is seen that the quality of speech is degraded by a significant amount by an increased amount of decorrelation.

The concept as discussed within the embodiments herein may be able to overcome any such issues when rendering a MASA derived audio stream (MASA parametric data+audio transport signals). That is embodiments discussed herein may comprise features which produce rendered multichannel audio signals which have the desired benefit of preserving the advantage of using a predefined downmix matrix without the deteriorating effect of introducing decorrelation into the rendered multichannel audio signal.

The embodiments therefore relate to parametric spatial sound rendering. The spatial parameter estimation may be based on microphone array signals. One example of determining spatial metadata involving directions and ratio parameters is Directional Audio Coding (DirAC) such as discussed in Pulkki, V., 2007. Spatial sound reproduction with directional audio coding. Journal of the Audio Engineering Society, 55(6), pp. 503-516, which uses as an input first-order capture signals. A variant of DirAC is the Higher-order DirAC Politis, A., Vilkamo, J. and Pulkki, V., 2015, “Sector-based parametric sound field reproduction in the spherical harmonic domain”, IEEE Journal of Selected Topics in Signal Processing, 9(5), pp. 852-866, which provides a multitude of simultaneous directional estimates. Many further parameter estimation methods exist any of which may be implemented in some embodiments, for example, GB published patent application GB1619573.7 described suitable means to obtain 360/3D spatial metadata from horizontally flat devices such as mobile phones. Any of the known spatial metadata determination techniques may be applied for some embodiments.

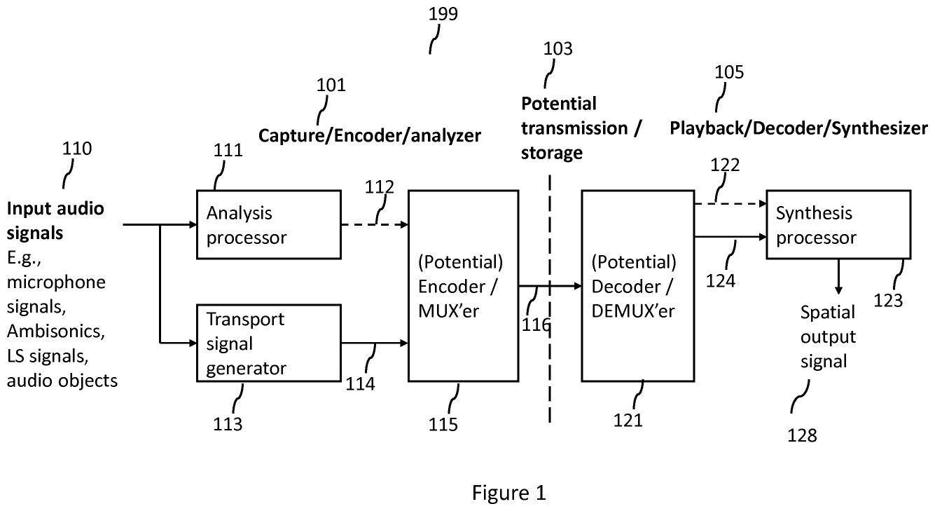

We will initially discuss the embodiments with respect to an example capture (or encoder/analyser) and playback (or decoder/synthesizer) apparatus or system as shown in FIG. 1.

The system 199 is shown with capture (encoder/analyser) 101 part and a playback (decoder/synthesizer) 105 part.

The capture part 101 in some embodiments comprises an audio signals input configured to receive input audio signals 110. The input audio signals can be from any suitable source, for example: two or more microphones mounted on a mobile phone; other microphone arrays, e.g., B-format microphone or Eigenmike; Ambisonic signals, e.g., first-order Ambisonics (FOA), higher-order Ambisonics (HOA); Loudspeaker surround mix and/or objects. The input audio signals 110 may be provided to an analysis processor 111 and to a transport signal generator 113.

The capture part 101 may comprise an analysis processor 111. The analysis processor 111 is configured to perform spatial analysis on the input audio signals yielding suitable metadata 112. The purpose of the analysis processor 111 is thus to estimate spatial metadata in frequency bands. For all of the aforementioned input types, there exists known methods to generate suitable spatial metadata, for example directions and direct-to-total energy ratios (or similar parameters such as diffuseness, i.e., ambient-to-total ratios) in frequency bands. These methods are not detailed herein, however, some examples may comprise the performing of a suitable time-frequency transform for the input signals, and then in frequency bands when the input is a mobile phone microphone array, estimating delay-values between microphone pairs that maximize the inter-microphone correlation, and formulating the corresponding direction value to that delay (as described in GB Patent Application Number 1619573.7 and PCT Patent Application Number PCT/FI2017/050778), and formulating a ratio parameter based on the correlation value. The direct-to-total energy ratio parameter for multi-channel captured microphone array signals can be estimated based on the normalized cross-correlation parameter cor′(k, n) between a microphone pair at band k, the value of the cross-correlation parameter lies between −1 and 1. A direct-to-total energy ratio parameter r(k, n) can be determined by comparing the normalized cross-correlation parameter to a diffuse field normalized cross correlation parameter cor_{D}′(k, n) as

$$r ( k , n ) = \frac{{cor}^{′} ( k , n ) - c o {r}_{D}^{′} ( k , n )}{1 - c o {r}_{D}^{′} ( k , n )} .$$

The direct-to-total energy ratio is explained further in PCT publication WO2017/005978 which is incorporated herein by reference.

The metadata can be of various forms and can contain spatial metadata and other metadata. A typical parameterization for the spatial metadata is one direction parameter in each frequency band characterized as an azimuth value ϕ(k, n) value and elevation value θ (k, n) and an associated direct-to-total energy ratio in each frequency band r(k, n), where k is the frequency band index and n is the temporal frame index. Determining or estimating the directions and the ratios depends on the device or implementation from which the audio signals are obtained. For example the metadata may be obtained or estimated using spatial audio capture (SPAC) using methods described in GB Patent Application Number 1619573.7 and PCT Patent Application Number PCT/FI2017/050778. In other words, in this particular context, the spatial audio parameters comprise parameters which aim to characterize the sound-field.

The spatial metadata in some embodiments may contain information to render the audio signals to a spatial output, for example to a binaural output, surround loudspeaker output, crosstalk cancel stereo output, or Ambisonic output. For example, in some embodiments the spatial metadata may further comprise any of the following (and/or any other suitable metadata):
loudspeaker level information;
inter-loudspeaker correlation information;
information on the amount of spread coherent sound;
information on the amount of surrounding coherent sound; and
loudspeaker setup.

In embodiments the loudspeaker setup may be a simple value indicating the type of speaker setup input at the encoder such as 5.1, 7.1, 6.1, 3.0 or 4.0.

In some embodiments the parameters generated may differ from frequency band to frequency band. Thus, for example in band X all of the parameters are generated and transmitted, whereas in band Y only one of the parameters is generated and transmitted, and furthermore in band Z no parameters are generated or transmitted. A practical example of this may be that for some frequency bands such as the highest band some of the parameters are not required for perceptual reasons.

When the input is a FOA signal or B-format microphone the analysis processor 111 can be configured to determine parameters such as an intensity vector, based on which the direction parameter is obtained, and to compare the intensity vector length to the overall sound field energy estimate to determine the ratio parameter. This method is known in the literature as Directional Audio Coding (DirAC).

When the input is HOA signal, the analysis processor 111 may either take the FOA subset of the signals and use the method above, or divide the HOA signal into multiple sectors, in each of which the method above is utilized. This sector-based method is known in the literature as higher order DirAC (HO-DirAC). In this case, there is more than one simultaneous direction parameter per frequency band.

When the input is loudspeaker surround mix and/or objects, the analysis processor 111 may be configured to convert the signal into a FOA signal(s) (via use of spherical harmonic encoding gains) and to analyse direction and ratio parameters as above.

As such the output of the analysis processor 111 is spatial metadata determined in frequency bands. The spatial metadata may involve directions and energy ratios in frequency bands but may also have any of the metadata types listed previously. The spatial metadata can vary over time and over frequency.

In some embodiments the spatial analysis may be implemented external to the system 199. For example, in some embodiments the spatial metadata associated with the audio signals may be provided to an encoder as a separate bit-stream. In some embodiments the spatial metadata may be provided as a set of spatial (direction) index values.

The capture part 101 may comprise a transport signal generator 113. The transport signal generator 113 is configured to receive the input signals and generate a suitable transport audio signal 114. The transport audio signal may be a multi-channel (e.g. such as a stereo pair and an additional mono), stereo, binaural or mono audio signal. The generation of transport audio signal 114 can be implemented using a known method such as summarised below.

When the input is mobile phone microphone array audio signals, the transport signal generator 113 may be configured to select a left-right microphone pair, and applying suitable processing to the signal pair, such as automatic gain control, microphone noise removal, wind noise removal, and equalization.

When the input is a FOA/HOA signal or B-format microphone, the transport signal generator 113 may be configured to formulate directional beam signals towards left and right directions, such as two opposing cardioid signals.

When the input is loudspeaker surround mix and/or objects, the transport signal generator 113 may be configured to generate a downmix signal that combines left side channels to left downmix channel, and same for right side, and adds centre channels to both transport channels with a suitable gain.

In some embodiments the input audio signals bypass the transport signal generator 113. For example, in some situations, where the analysis and synthesis occur at the same device at a single processing step, without intermediate encoding. The number of transport channels can also be any suitable number (rather than one or two channels as discussed in the examples).

In some embodiments the capture part 101 may comprise an encoder/multiplexer 115. The encoder/multiplexer 115 can be configured to receive the transport audio signals 114 and the metadata 112. The encoder/multiplexer 115 may furthermore be configured to generate an encoded or compressed form of the metadata information and transport audio signals. In some embodiments the encoder/multiplexer 115 may further interleave, multiplex to a single data stream 116 or embed the metadata within encoded audio signals before transmission or storage. The multiplexing may be implemented using any suitable scheme.

The encoder/multiplexer 115 for example could be implemented as an IVAS encoder, or any other suitable encoder. The encoder/multiplexer 115 thus is configured to encode the audio signals and the metadata and form a bit stream 116 (e.g., an IVAS bit stream).

This bitstream 116 may then be transmitted/stored 103 as shown by the dashed line. In some embodiments there is no encoder/multiplexer 115 (and thus no decoder/demultiplexer 121 as discussed hereafter).

The system 199 furthermore may comprise a playback (decoder/synthesizer) part 105. The playback part 105 is configured to receive, retrieve or otherwise obtain the bitstream 116, and from the bitstream generate suitable audio signals to be presented to the listener/listener playback apparatus.

The playback part 105 may comprise a decoder/demultiplexer 121 configured to receive the bitstream and demultiplex the encoded streams and then decode the audio signals to obtain the transport signals 124 and metadata 122.

Furthermore in some embodiments, as discussed above there may not be any demultiplexer/decoder 121 (for example where there is no associated encoder/multiplexer 115 as both the capture part 101 and the playback part 105 are located within the same device).

The playback part 105 may comprise a synthesis processor 123. The synthesis processor 123 is configured to obtain the transport audio signals 124, the spatial metadata 122 and produce a spatial output signal 128 for example a binaural audio signal that can be reproduced over headphones.

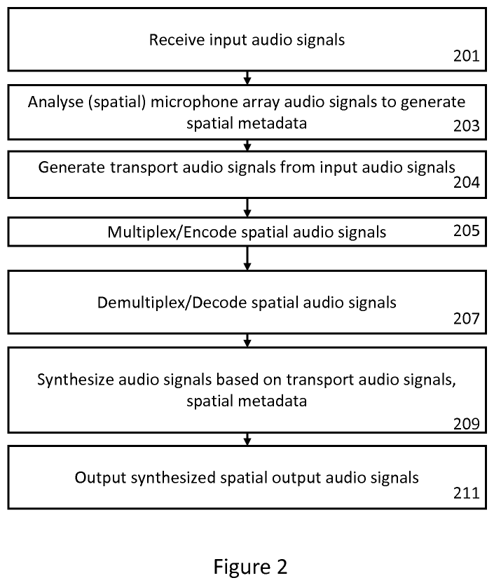

The operations of this system are summarized with respect to the flow diagram as shown in FIG. 2.

FIG. 2 shows for example the receiving of the input audio signals as shown in step 201.

Then the flow diagram shows the analysis (spatial) of the input audio signals to generate the spatial metadata as shown in FIG. 2 by step 203.

The transport audio signals are then generated from the input audio signals as shown in FIG. 2 by step 204.

The generated transport audio signals and the metadata may then be encoded and/or multiplexed as shown in FIG. 2 by step 205. This is shown in FIG. 2 as an optional dashed box.

The encoded and/or multiplexed signals can furthermore be demultiplexed and/or decoded to generate transport audio signals and spatial metadata as shown in FIG. 2 by step 207. This is also shown as an optional dashed box.

Then spatial audio signals can be synthesized based on the transport audio signals and spatial metadata as shown in FIG. 2 by step 209.

The synthesized spatial audio signals may then be output to a suitable output device, for example a set of headphones, as shown in FIG. 2 by step 211.

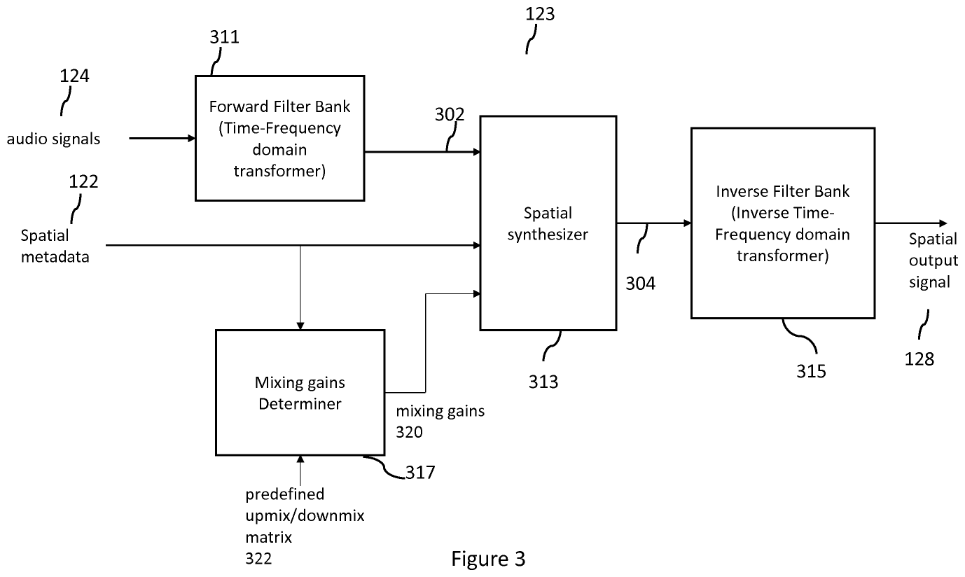

With respect to FIG. 3 is shown the synthesis processor 123 in further detail.

In some embodiments the synthesis processor 123 comprises a Forward Filter Bank (time-frequency transformer) 311. The Forward Filter Bank (time-frequency transformer) 311 is configured to receive the (time-domain) transport audio signals 124 and convert them to the time-frequency domain. Suitable forward filters or transforms include, e.g., short-time Fourier transform (STFT) and complex-modulated quadrature mirror filterbank (QMF). The resulting signals may be denoted as xᵢ(b, n), where i is the channel index, b the frequency bin index of the time-frequency transform, and n the time index. The time-frequency signals are for example expressed here in a vector form (for example for two channels the vector form is):

$$x ( b , n ) = [ \begin{matrix}{x}_{1} ( b , n ) \\ {x}_{2} ( b , n )\end{matrix} ]$$

The following processing operations may then be implemented within the time-frequency domain and over frequency bands. A frequency band can be one or more frequency bins (individual frequency components) of the applied time-frequency transformer (filter bank). The frequency bands could in some embodiments approximate a perceptually relevant resolution such as the Bark frequency bands, which are spectrally more selective at low frequencies than at the high frequencies. Alternatively, in some implementations, frequency bands can correspond to the frequency bins. The frequency bands may be those (or approximate those) where the spatial metadata has been determined by the analysis processor. Each frequency band k may be defined in terms of a lowest frequency bin b_{low}(k) and a highest frequency bin b_{high}(k).

The time-frequency transport signals 302 in some embodiments may be provided to a spatial synthesizer 313.

The synthesis processor 123 in some embodiments comprises a spatial synthesizer 313 configured to receive the time-frequency domain transport signals 302, spatial metadata 122 and mixing gains 320 and generate spatial time-frequency audio signals 304 by processing of the time-frequency transport signals 302 based on the spatial metadata 122.

The synthesis processor 123 in some embodiments comprises an Inverse Filter Bank 315 configured to receive the spatial time-frequency domain audio signals 304 and applies an inverse transform corresponding to the transform applied by the Forward Filter Bank 311 to generate a time domain spatial output signal 128. The output of the Inverse Filter Bank 315 may thus be spatial output signal 128, which could be, for example, a binaural audio signal for headphone listening.

Also shown in FIG. 3 is the mixing gains determiner 317. The mixing gains determiner 317 may be configured to receive the spatial metadata 122 (including the loudspeaker setup) along with the predefined upmix/downmix matrix 322. The mixing gains determiner 317 may then be arranged to determine the mixing gains 320 for use in the subsequent mixing stage performed in the spatial synthesiser 313.

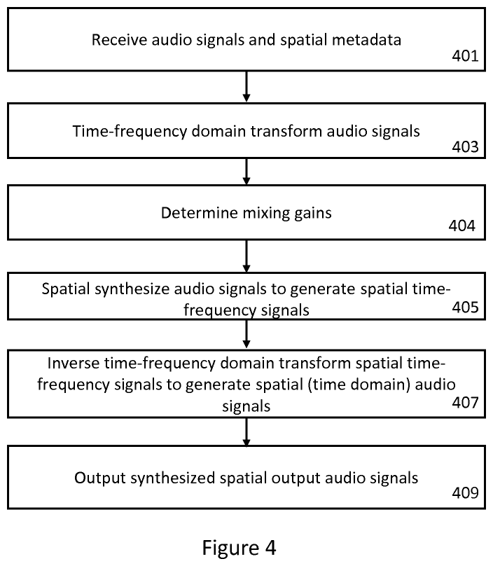

The operations of this synthesis processor 123 are summarized with respect to the flow diagram as shown in FIG. 4.

FIG. 4 shows for example the receiving of the audio signals and spatial metadata as shown in step 401.

Then the audio signals are time-frequency domain transformed to generate the time-frequency domain audio signals as shown in FIG. 4 by step 403.

The mixing gains are determined from a predefined upmix/downmix matrix 322 and the spatial metadata received as part of step 401. The mixing gains determining step is shown in FIG. 4 by step 404.

The time-frequency domain audio signals are then processed based on the mixing gains 320 to generate spatial time-frequency domain audio signals as shown in FIG. 4 by step 405.

The spatial time-frequency domain audio signals can then in be inverse transformed to generate spatial (time domain) audio signals as shown in FIG. 4 by step 407.

The synthesized spatial audio signals can then be output as shown in FIG. 4 by step 409.

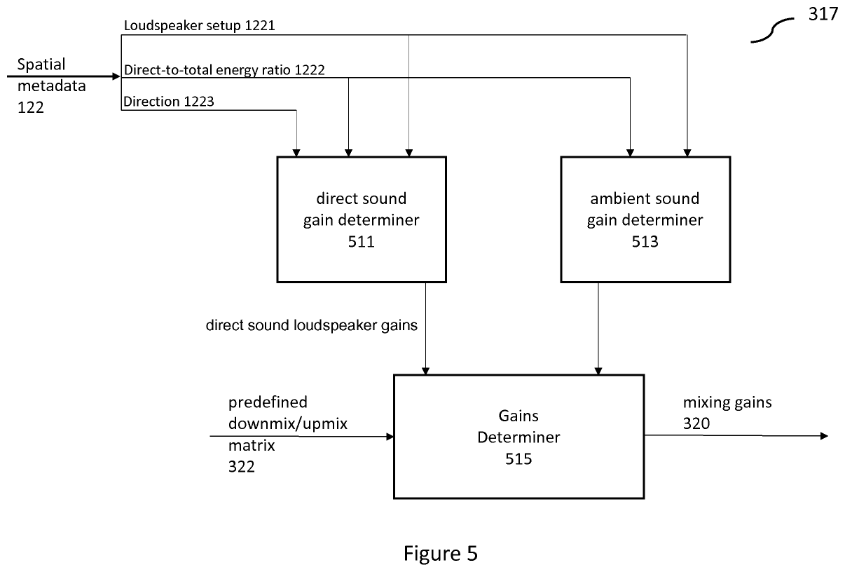

An example of the mixing gains determiner 317 of FIG. 3 is shown in further detail in FIG. 5. In the following example the audio signals comprise two channels, one “left” and one “right” channel. However, it would be understood that there are embodiments which may implement the same methods for any number of channels by a person skilled in the art without any further inventive input.

As shown in FIG. 5, the direct sound gain determiner 511 may be arranged to receive the following constituent members of the spatial metadata 122; the directions comprising for each frequency band k and a temporal time index n the azimuth value ϕ(k, n) value and the elevation value θ (k, n) 1223, the associated direct-to-total energy ratio in each frequency band k and temporal time index n r(k,n) 1222 and the loudspeaker setup 1221. In embodiments the loudspeaker setup may be a simple value indicating an index. The direct sound gain determiner 511 may be able to ascertain the actual loudspeaker setup (such as 5.1 or 7.1) by the process of mapping the index to a table of stored loudspeaker positions.

Using the above parameters, the direct sound gain determiner 511 may be be configured to determine for each loudspeaker a set panning gains denoted as gₚₐₙ(k, n, i), where i is the loudspeaker channel. The gains for the LFE channels can be excluded from this calculation as these channels typically only produce low frequencies. The panning gains can be determined using prior art techniques such as Vector Base Amplitude Panning (VBAP). Techniques which are readily familiar to the person skilled in the art. However, it should be understood, that the panning gains determined by the direct sound gain determiner 511 are energy-based gain values, i.e. gain values which are suitable for multiplying with other energy values. Algorithms such as VBAP typically produce amplitude-based gain values for direct application to the audio signal by the process of multiplication. Consequently, in embodiments the gain values as produced by prior art algorithms such as VBAP are simply squared in order to produce the suitable panning gains for application in the following steps.

The direct sound loudspeaker gain for each frequency band k and temporal time index n g_{dir}(k, n, i) and for each input channel i may be calculated by the direct sound gain determiner 511 as

$${g}_{dir} ( k , n , i ) = {g}_{pan} ( k , n , i ) r ( k , n ) .$$

The direct sound loudspeaker gains g_{dir}(k, n, i) may then be passed to the gains determiner 515.

Additionally, the mixing gains determiner 317 may be arranged to determine ambient sound loudspeaker gains g_{amb}(k, n, i). This is depicted in FIG. 5 by the ambient sound gain determiner functional block 513. As shown in FIG. 5, the ambient sound gain determiner 513 is arranged to use the loudspeaker setup 1221 and direct-to-total energy ratios 1222 in order to determine the ambient sound loudspeaker gains g_{amb}(k, n, i). Again, this calculation is also performed for each frequency band n, temporal time index n and loudspeaker input channel i. In embodiments the ambient sound loudspeaker gains g_{amb}(k, n, i) may be determined as

$${g}_{amb} ( k , n , i ) = \frac{1 - r ( k , n )}{I}$$

where I is the number of input loudspeaker channels (excluding the LFE channel). In this example embodiment the ambient energy is distributed equally to all loudspeakers.

In other examples, the ambient energy distribution may be non-even, for example, proportionally more ambience energy could be distributed to those loudspeakers that correspond to directions where the spatial density of the loudspeakers is smaller.

As an aside, it may be noted that the sum of gains gₚₐₙ(k, n, i) over all loudspeakers should be unity. Therefore this should lead to the sum of the gains g_{dir}(k, n, i)+g_{amb}(k, n, i) over all loudspeakers to also be equal to unity.

The ambient sound loudspeaker gains g_{amb}(k, n, i) may also then be passed to the gains determiner 515 for further processing.

The gains for the subsequent spatial synthesizer 313 may be determined by the functional processing block gains determiner 515. These mixing gains (for use by subsequent mixing in the spatial synthesizer 313) may be determined from the direct and ambient loudspeaker gains and a predefined downmix/upmix matrix 322.

In embodiments the gains determiner 515 may be arranged to firstly, estimate (or model) the spectral effect from rendering sound in a multichannel loudspeaker setup (e.g. 5.1) (upmix) and secondly estimate how the sound would be attenuated or amplified in the time-frequency domain according to the effect of the downmix. These estimations may then be used to determine suitable mixing gains which deliver the desired spectral effects in the following spectral synthesis stage 313.

This approach, used for determining the mixing gains 320, results in the technical advantage of avoiding the need to perform rendering to a multichannel signal before rendering back down to simpler channel structure (such as a stereo or binaural pair). Instead the desired spectral effects of downmixing/upmixing rendering may be directly delivered in the form of the determined values of the mixing gains before being applied to the subsequent mixing matrix. Therefore, using this approach, for determining the mixing gains 320, can result in the technical advantage of saving computational power whilst maintaining the desired spectral effects of a downmixing/upmixing rendering.

As stated previously the gains are calculated based on maintaining the desired spectral effects of a downmixing/upmixing rendering. To this extent one of the inputs to the gains determiner 515 may be the downmix/upmix matrix 322 whose characteristics are used to determine the mixing gains 320. In other words, the downmix/up matrix 322 provides the above desired features from which the mixing gains 320 are generated.

In embodiments the upmix/downmix matrix 322 may be formed as a matrix of gains. Where each column of the matrix represents a vector of gain terms for converting one channel of an input audio signal into an upmixed/downmixed signal. For example, we might define a upmix/downmix matrix 322 which would convert a 5.0 multichannel audio signal to a stereo audio signal. In this instance the matrix would have 5 rows and 2 columns in order to perform the reduction from 5 channels to 2 channels. Furthermore, the components (or gain terms) of the matrix 322 may be chosen based on channel gain terms required to perform the mixing on a “standalone” multichannel audio signal. For instance, using the above example, the first column of the matrix may comprise the component gain terms of gₘₜₓ′(i, 1)=[1, 0, 0.7, 0.7, 0], in order to perform the reduction from 5.0 multichannel audio signal to the right channel of the output stereo pair. Similarly, the left channel of the stereo pair may be formed from the 5.0 multichannel audio signal by using the column vector gₘₜₓ′(i, 2)=[0, 1, 0.7, 0, 0.7]. Note the channels are in the following order for this example, [front left, front right, centre, side left, side right]. Also “0.0” in this example 5.0 indicates that the LFE channel is not considered.

Therefore, for this example where a 5.0 multichannel signal is rendered to a stereo pair the predefined upmix/downmix matrix 322 (as input to the gains determiner 515) may be.

$$[ \begin{matrix}1 & 0 \\ 0 & 0.7 \\ 0.7 & 0.7 \\ 0.7 & 0 \\ 0 & 0.7\end{matrix} ]$$

In other words, the upmix/downmix matrix 322 may have components which reflect the gain terms required to perform act of upmixing and downmixing for a multichannel audio signal in a standalone situation or environment.

In another example a 5.1 multichannel signal may be rendered to a stereo pair. In this case the predefined upmix/downmix matrix 322 may have the column vectors [1, 0, 0.7, 0.7, 0.7, 0] and [0, 1, 0.7, 0.7, 0, 0.7].

As explained above the predefined upmix/downmix matrix 322 may form an input to the gains determiner 515. Alternatively, the predefined upmix/downmix matrix 322 may be stored in the gains determiner 515.

In embodiments the gains determiner 515 may convert the gains of the predefined upmix/downmix matrix 322 into energy-based gains. This may be performed by simply squaring each term of the predefined upmix/downmix matrix 322 i.e. gₘₜₓ(i, j)=gₘₜₓ′(i, j)², where j is the output channel index. For the above example j would have values 0 and 1 (or 1 and 2).

The gains determiner 515 may determine the gain energy of each input channel (also known as channel gain) by summing the gain entries across all output channels j

$${g}_{mtx , sum} ( i ) = {\sum }_{j} {g}_{mtx} ( i , j ) for all i$$

Returning to the above example of downmixing a 5.0 multichannel audio signal to a stereo pair the energy of each input channel may be expressed as the row vector

$${g}_{mtx , s u m} = [ 1 , 1 , 1 , 0.5 , 0.5 ] .$$

This row vector of input channel energies has the effect of attenuating the side channels by 3 dB whilst keeping the energies of the other channels unmodified.

Note, the predefined upmix/downmix matrix 322 may be determined in accordance to the loudspeaker setup input to the mixing gains determiner 317. In embodiments the mixing gains determiner 317 may store a predefined upmix/downmix matrix 322 for each possible loudspeaker setup. In other embodiments the mixing gains determiner 317 may instead store the row vector holding the energy of each input channel commensurate with each loudspeaker setup.

The gains determiner 515 may then be configured to determine the mixing gains gₘᵢₓ(k, n) by considering the gain energy of each input channel g_{mtx,sum}(i) together with the ambient sound loudspeaker gains g_{amb}(k, n, i), and direct sound loudspeaker gains g_{dir}(k, n, i). The mixing gains gₘᵢₓ(k, n) may then be used in the subsequent spatial synthesis stage 313.

In embodiments the mixing gains gₘᵢₓ(k, n) may be determined as

$${g}_{m i x} ( k , n ) = {\sum }_{i} {g}_{mtx , s u m} ( i ) ( {g}_{d i r} ( k , n , i ) + {g}_{amb} ( k , n , i ) )$$

where it can be seen that the mixing gain gₘᵢₓ(k, n) is determined by summing the expression g_{mtx,sum}(i)(g_{dir}(k, n, i)+g_{amb}(k, n, i)) across all input channels of the above discussed predefined upmix/downmix matrix 322. So, referring back to the above example of rendering multichannel 5.1 audio signal to a stereo pair, i will run from 0 to 4, remembering that the LFE channel has been ignored in determining g_{mtx,sum}(i). It can be seen from the above expression that the mixing gains are determined on a per frequency sub band k and time index n basis.

In another embodiment the LFE channel may be included (e.g. 5.1) when determining the mixing gains gₘᵢₓ(k, n). These embodiments rely on an LFE-to-total energy ratio being transmitted as part of the spatial metadata 122. In these embodiments the LFE channel may be taken into account by determining the LFE sound loudspeaker gain g_{LFE}(k, n, i) by setting the value of g_{LFE}(k, n, i) for i=LFE_channel to be the LFE-to-total energy ratio whilst setting all other values of G_{LFE}(k, n, i) for i≠LFE_channel to zero. In this case the ambient sound loudspeaker gain g_{amb}(k, n, i) and the direct sound loudspeaker gain B_{dir}(k, n, i) for the channel i=LFE_channel may be adjusted by multiplying the respective value of the gain by the factor 1-LFE_to_total energy ratio.

It may be noted that the LFE_to_total energy ratio may only have values below 120 Hz, above this frequency the LFE_to_total energy ratios are typically zero. Accordingly, the value of g_{LFE}(k, n, i) may only be considered below this frequency.

In this embodiment the mixing gains may be determined as

$${g}_{m i x} ( k , n ) = {\sum }_{i} {g}_{mtx , s u m} ( i ) ( {g}_{d i r} ( k , n , i ) + {g}_{amb} ( k , n , i ) + {g}_{L F E} ( k , n , i ) )$$

In another embodiment, the downmix/upmix matrix 322 may be applied at the encoder for example, when the downmixing from a 5.1 multichannel audio signal to the stereo audio transport signal. In this case, at the decoder, the decoded stereo transport signals may be in a suitable form for a direct output, should it be desired to have a stereo output audio signal with the characteristics of the downmix/upmix matrix 322 at the encoder. However, for a multichannel or binaural output it may not be desirable to have that effect of a stereo output from a multichannel input. That is the effect of attenuating the side loudspeakers, as discussed previously. In this case, the processing can be modified in way that the downmix/upmix matrix 322 is first inverted

$$( {g}_{mtx , i n v}^{′} ( i , j ) = \frac{1}{{g}_{m t x}^{′} ( i , j )} ) ,$$

with the rest of the processing performed as described above, however instead using g_{mtx,inv}′(i, j). Moreover, if some other downmix/upmix combination is desired at the decoder, the inverted original matrix can be multiplied with the new matrix, and the resulting product matrix can be used for the subsequent processing.

As stated previously the mixing gains gₘᵢₓ(k, n) 320 forms the output of the mixing gains determiner 317. The mixing gains gₘᵢₓ(k, n) 320 are then passed to the spatial synthesizer 313.

In addition to the mixing gains gₘᵢₓ(k,n) 320 the spatial synthesizer may be arranged to receive the time-frequency audio signals 302 and the spatial metadata 122.

It is to be appreciated that the term mixing gain gₘᵢₓ(k,n) may be referred to as a mixing value because in effect these “gains” are not directly used for mixing in the spatial synthesizer 313 but rather impart the effect of (or characteristics of) rendering from one multichannel configuration to another multichannel configuration, such as a 5.1 multichannel audio signal to a stereo audio signal.

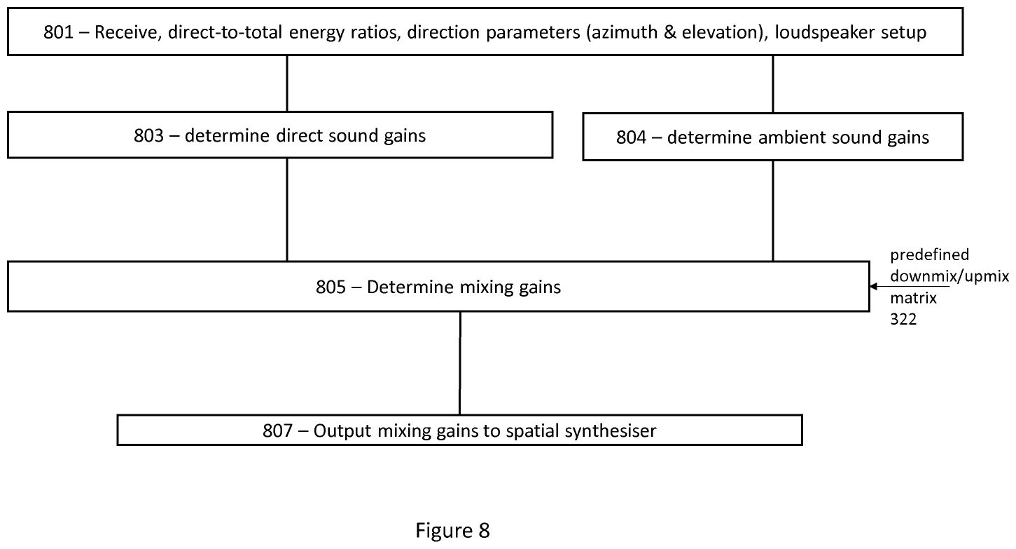

The operations of the mixing gains determiner 317 are summarized with respect to the flow diagram as shown in FIG. 8.

The inputs, such as Loudspeaker setup 1221, spatial audio direction parameters 1223 and direct-to-total energy ratios 1222 are received as shown in FIG. 8 by step 801.

The next operation is determining the direct sound gain from the inputs Loudspeaker setup 1221, spatial audio direction parameters 1223 and direct-to-total energy ratios 1222 as shown in FIG. 8 by step 803. Also, the operation of determining the ambient sound gain from the loudspeaker setup 1221 and direct-to-total energy ratios 1222 is shown as processing step 804.

The mixing gains are then generated based on the predetermined upmix/downmix matrix target covariance matrix as shown in FIG. 8 by step 805.

The mixing gains are then output as shown in FIG. 8 by step 811.

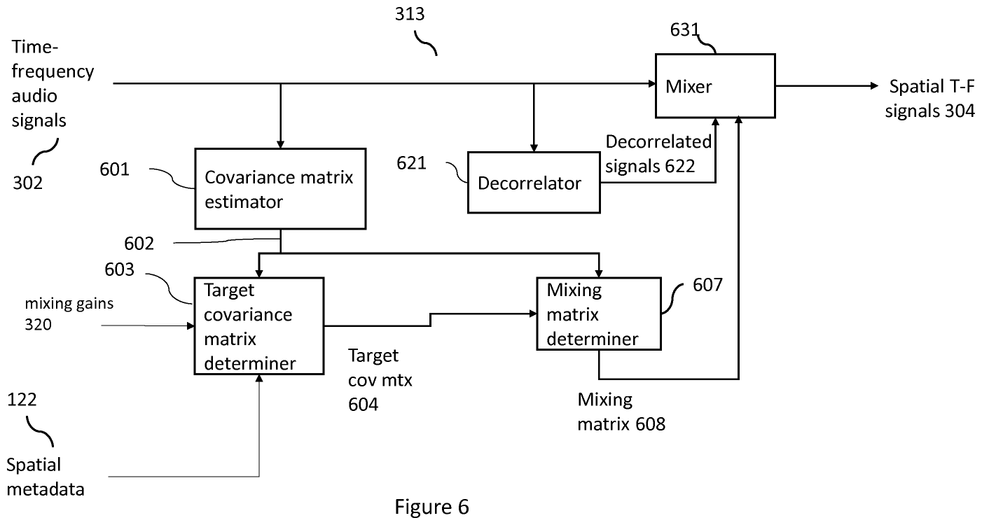

An example of the spatial synthesiser 313 of FIG. 3 is shown in further detail in FIG. 6.

As shown in FIG. 6, the time-frequency audio signals 302 can be provided to a mixer 631, decorrelator 621 and covariance matrix estimator 601. The spatial metadata 122 is provided to a target covariance matrix determiner 603.

In some embodiments the spatial synthesiser 313 comprises a covariance matrix estimator 601. The covariance matrix estimator 601 is configured to receive the time-frequency audio signals 302 and estimates a covariance matrix of the time-frequency audio signals and their overall energy estimate (in frequency bands). The covariance matrix can for example in some embodiments be estimated as:

$${C}_{x} ( k , n ) = {\sum }_{b = {b}_{l o w} ( k )}^{{b}_{high} ( k )} x ( b , n ) {x}^{H} ( b , n ) .$$

where superscript H denotes a complex conjugate and b_{low}(k) and b_{high}(k) are the lowest and highest bin indices of frequency band k. The frequency bins can in some embodiments be the bins of the applied time-frequency transform, and the frequency bands are typically configured to contain a larger number of bins towards the higher frequencies. The frequency bands may be such that at which the spatial metadata has been determined. In some embodiments Cₓ(k,n) is averaged over time using a FIR or IIR (or any) window. The estimated covariance matrix 602 can in some embodiments be output to a target covariance matrix determiner 603 and a mixing matrix determiner 607.

In some embodiments the spatial synthesiser 313 comprises a target covariance matrix determiner 603. The target covariance matrix determiner 603 is configured to receive the estimated covariance matrix 602, the spatial metadata 122 and mixing gains gₘᵢₓ 320. From these inputs, the target covariance matrix estimator 603 is then arranged to generate a target covariance matrix 604 for the specific channel configuration of the output loudspeaker signal.

The target covariance matrix determiner 603 in some embodiments is configured to first determine an overall energy value E(k, n) as the sum (or mean) of the diagonal elements of Cₓ(k, n). In some embodiments this value can be determined in the covariance matrix estimator 601.

As part of the process of generating the target covariance matrix, the target covariance matrix determiner 603 may generate a panning gain vector g on a per frequency sub band k and temporal index n basis. For example, in the case of stereo output, the panning gain vector g may be determined by considering the gains from a left and right channel as determined by the VBAP law for loudspeakers. In this example the panning gain vector g may be given as

$$g ( k , n ) = \{ \begin{matrix}{\begin{matrix}[ 1 & 0 ]\end{matrix}}^{T} , & when θ ( k , n ) \geq 30 ° \\ {\begin{matrix}[ {g}_{L} ( θ ( k , n ) ) & {g}_{R} ( θ ( k , n ) ) ]\end{matrix}}^{T} , & when 30 ° > θ ( k , n ) > - 30 ° \\ {\begin{matrix}[ 0 & 1 ]\end{matrix}}^{T} , & when θ ( k , n ) \leq - 30 °\end{matrix}$$

where g_{L} (θ(k, n)) and g_{R} (θ(k, n)) are the gains from the vector base amplitude panning (VBAP) law for loudspeakers at ±30°, where θ(k, n) is the azimuth value for the time frequency tile k, n from the spatial metadata input 122. The g_{L} (θ(k, n)) and g_{R} (θ(k,n)) are given by

$${g}^{′} ( θ ( k , n ) ) = [ \begin{matrix}{g}_{1}^{′} ( θ ( k , n ) ) \\ {g}_{2}^{′} ( θ ( k , n ) )\end{matrix} ] = [ \begin{matrix}{3}^{- 1 / 2} & 1 \\ {3}^{- 1 / 2} & - 1\end{matrix} ] [ \begin{matrix}cos ( θ ( k , n ) ) \\ sin ( θ ( k , n ) )\end{matrix} ]$$

$$and$$

$$[ \begin{matrix}{g}_{L} ( θ ( k , n ) ) \\ {g}_{R} ( θ ( k , n ) )\end{matrix} ] = \frac{{g}^{′} ( θ ( k , n ) )}{\sqrt{{( {g}^{′} ( θ ( k , n ) ) )}^{T} {g}^{′} ( θ ( k , n ) )}}$$

The target covariance matrix estimator 603 may then formulate the target covariance matrix using the mixing gains gₘᵢₓ(k, n) the direct-to-total energy ratio r(k, n) and the overall energy estimates E(k, n). The target covariance matrix may be given as

$${C}_{t a r g e t} ( k , n ) = {g}_{m i x} ( k , n ) E ( k , n ) ( g ( k , n ) {g}^{T} ( k , n ) r ( k , n ) + ( 1 - r ( k , n ) ) [ \begin{matrix}0.5 & 0 \\ 0 & 0.5\end{matrix} ] ) .$$

The target covariance matrix can then in some embodiments be output to the mixing matrix determiner 607 within the spatial synthesiser 313. The mixing matrix determiner 607 is configured to receive the target covariance matrix 604 and the estimated covariance matrix 602. The mixing matrix determiner 507 in some embodiments is configured to determine a mixing matrix. In some embodiments this determination may employ the method as described in Vilkamo, J., Bäckström, T. and Kuntz, A., 2013, “Optimized covariance domain framework for time-frequency processing of spatial audio”, Journal of the Audio Engineering Society, 61(6), pp. 403-411. This method utilizes a prototype matrix which may be set in the present context to

$$Q = [ \begin{matrix}1 & 0 \\ 0 & 1\end{matrix} ] .$$

In summary the embodiments are configured to provide a mixing matrix M(k, n) for non-decorrelated sound and Mᵣ(k, n) for decorrelated sound, which, when applied to the input signals having the covariance matrix Cₓ(k, n), provides output signals that have a covariance matrix that resembles the target covariance matrix C_{target}(k, n). This mixing solution may be least squares optimized with respect to a prototype signal Qx(b, n). The mixing matrix determiner 607 is configured to output the mixing matrices M(k, n) and Mᵣ(k, n) 608 to the mixer 631.

In other embodiments the mixing matrices M(k, n) for non-decorrelated sound and Mᵣ(k, n) for decorrelated sound may be formulated as

$$\begin{matrix}M ( k , n ) = [ \begin{matrix}\sqrt{\frac{{C}_{t a r g e t} ( k , n ) \{ 1 , 1 \}}{{C}_{x} ( k , n ) \{ 1 , 1 \}}} & 0 \\ 0 & \sqrt{\frac{{C}_{t a r g e t} ( k , n ) \{ 2 , 2 \}}{{C}_{x} ( k , n ) \{ 2 , 2 \}}}\end{matrix} ] \\ {M}_{r} ( k , n ) = [ \begin{matrix}0 & 0 \\ 0 & 0\end{matrix} ]\end{matrix}$$

where the brackets { } denote a selection of a single matrix entry from the covariance matrices 602 and 604. In this formulation of the mixing matrices 608 only the energy of the signals is compensated and whilst there is no effect on the phase or correlation between the channels. At high frequencies this may be the most robust option, and at high frequencies phase/correlation information also has smaller perceptual relevance than at the low frequencies.

In embodiments the spatial synthesiser 313 comprises a decorrelator 621. The decorrelator 621 is configured to receive the time-frequency audio signals x(b,n) 302 and generate a decorrelated d(b, n) version 622 thereof. The decorrelated audio signals d(b, n) 622 are then also passed to the mixer 631.

In embodiments the mixer 631 is configured to receive the time-frequency audio signals 302 and decorrelated audio signals d(b,n) 622 and generate a mix based on the mixing matrices 608 M(k, n) and Mᵣ(k, n). The mixer 631 can for example generate the output by

$$y ( b , n ) = M ( k , n ) x ( b , n ) + {M}_{r} ( k , n ) d ( b , n ) ,$$

where band index k is that where bin b resides. This output signal is the spatial time-frequency signals 304, which is the output of the spatial synthesizer as shown in FIG. 3.

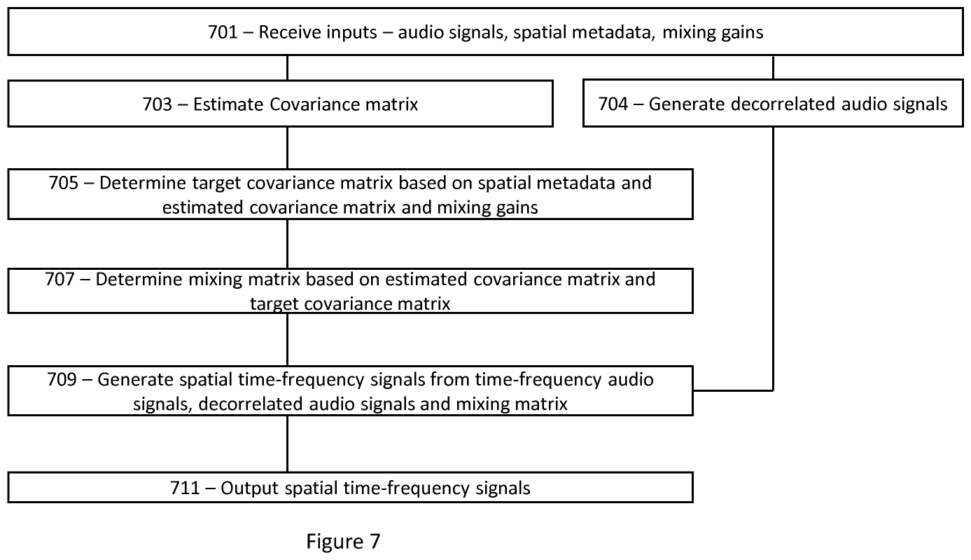

The operations of the spatial synthesiser 313 are summarized with respect to the flow diagram as shown in FIG. 7.

The inputs, such as time-frequency audio signals 302, spatial metadata 122 and derived mixing gains 320 are received as shown in FIG. 7 by step 701.

The next operation is one of estimating the covariance matrix as shown in FIG. 7 by step 703.

The target covariance matrix is then generated based on the spatial metadata estimated covariance matrix and mixing gains as shown in FIG. 7 by step 705.

The mixing matrix is then determined based on the estimated covariance matrix and target covariance matrix as shown in FIG. 7 by step 707.

The spatial time-frequency audio signals are then determined based on the time-frequency audio signals 313, decorrelated audio signals 622, and mixing matrix 608 as shown in FIG. 7 by step 709. With this the decorrelated audio signals are generated as shown in FIG. 7 by step 704.

The spatial time-frequency audio signals are then output as shown in FIG. 7 by step 711.

In some embodiments the spatial synthesizer 313 may solely comprise a gain applier function which applies the mixing gains 320 gₘᵢₓ(k, n) directly to the time-frequency audio signals 302.

The gain applier may perform the mixing function to the time-frequency audio signals 302 s(b, n) using the following operation

$${s}_{L S} ( b , n ) = [ \begin{matrix}\sqrt{{g}_{m i x} ( k , n )} & 0 \\ 0 & \sqrt{{g}_{m i x} ( k , n )}\end{matrix} ] s ( b , n )$$

In some embodiments temporal smoothing may be applied to \sqrt{gₘᵢₓ(k, n)} before the above operation at the spatial synthesizer 313 is performed.

Moreover, in some embodiments, it is also possible to use different mixing gains \sqrt{gₘᵢₓ(k, n, j)} for left and right channels, where j is a variable denoting whether the left or right channel. This may have a particular advantage for cases in which the downmix/upmix matrix is not symmetric in the left-right direction.

Again, these mixing gains can \sqrt{gₘᵢₓ(k, n, j)}, can also be applied directly to the time frequency signals 302. In this case, the mixing operation may be performed as

$${s}_{L S} ( b , n ) = [ \begin{matrix}\sqrt{{g}_{m i x} ( k , n , 1 )} & 0 \\ 0 & \sqrt{{g}_{m i x} ( k , n , 2 )}\end{matrix} ] s ( b , n )$$

However, in this case, the gains determiner 515 may operate in a different manner to as described above, in order to generate stereo gains. For example, initially the sound distribution at 5.1 (excluding LFE) channels is formulated as:

$${g}_{l s} ( k , n , i ) = {g}_{d i r} ( k , n , i ) + {g}_{amb} ( k , n , i )$$

As before gₘₜₓ′(i, j) denotes the component gain terms of the predetermined upmix/downmix matrix. Further a term g_{mtx,o}′(i, j) may be used to denote a original downmix matrix that would be applied at the encoder when obtaining the transport audio signals. In this example, we may formulate the mixing gains gₘᵢₓ(k, n, j) formulated as

$${g}_{m i x} ( k , n , j ) = \frac{{\sum }_{i} {g}_{mtx}^{′} ( i , j ) {g}_{l s} ( k , n , i )}{{\sum }_{i} {g}_{mtx , o}^{′} ( i , j ) {g}_{l s} ( k , n , i )}$$

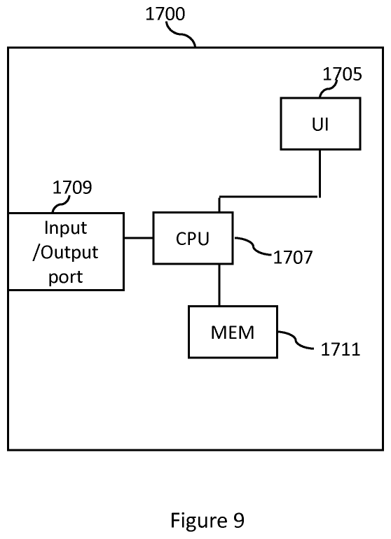

With respect to FIG. 9 an example electronic device which may be used as any of the apparatus parts of the system as described above. The device may be any suitable electronics device or apparatus. For example, in some embodiments the device 1700 is a mobile device, user equipment, tablet computer, computer, audio playback apparatus, etc. The device may for example be configured to implement the encoder/analyser part 101 and/or the decoder/synthesizer part 105 as shown in FIG. 1 or any functional block as described above.

In some embodiments the device 1700 comprises at least one processor or central processing unit 1707. The processor 1707 can be configured to execute various program codes such as the methods such as described herein.

In some embodiments the device 1700 comprises a memory 1711. In some embodiments the at least one processor 1707 is coupled to the memory 1711. The memory 1711 can be any suitable storage means. In some embodiments the memory 1711 comprises a program code section for storing program codes implementable upon the processor 1707. Furthermore, in some embodiments the memory 1711 can further comprise a stored data section for storing data, for example data that has been processed or to be processed in accordance with the embodiments as described herein. The implemented program code stored within the program code section and the data stored within the stored data section can be retrieved by the processor 1707 whenever needed via the memory-processor coupling.

In some embodiments the device 1700 comprises a user interface 1705. The user interface 1705 can be coupled in some embodiments to the processor 1707. In some embodiments the processor 1707 can control the operation of the user interface 1705 and receive inputs from the user interface 1705. In some embodiments the user interface 1705 can enable a user to input commands to the device 1700, for example via a keypad. In some embodiments the user interface 1705 can enable the user to obtain information from the device 1700. For example the user interface 1705 may comprise a display configured to display information from the device 1700 to the user. The user interface 1705 can in some embodiments comprise a touch screen or touch interface capable of both enabling information to be entered to the device 1700 and further displaying information to the user of the device 1700. In some embodiments the user interface 1705 may be the user interface for communicating.

In some embodiments the device 1700 comprises an input/output port 1709. The input/output port 1709 in some embodiments comprises a transceiver. The transceiver in such embodiments can be coupled to the processor 1707 and configured to enable a communication with other apparatus or electronic devices, for example via a wireless communications network. The transceiver or any suitable transceiver or transmitter and/or receiver means can in some embodiments be configured to communicate with other electronic devices or apparatus via a wire or wired coupling.

The transceiver can communicate with further apparatus by any suitable known communications protocol. For example in some embodiments the transceiver can use a suitable radio access architecture based on long term evolution advanced (LTE Advanced, LTE-A) or new radio (NR) (or can be referred to as 5G), universal mobile telecommunications system (UMTS) radio access network (UTRAN or E-UTRAN), long term evolution (LTE, the same as E-UTRA), 2G networks (legacy network technology), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs), cellular internet of things (IoT) RAN and Internet Protocol multimedia subsystems (IMS), any other suitable option and/or any combination thereof.

The transceiver input/output port 1709 may be configured to receive the signals.

In some embodiments the device 1700 may be employed as at least part of the synthesis device. The input/output port 1709 may be coupled to headphones (which may be a headtracked or a non-tracked headphones) or similar and loudspeakers.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general-purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. An apparatus comprising at least one processor and at least one memory including computer program code, the at least one memory and the computer program code configured to, with the at least one processor, cause the apparatus to:
receive a spatial audio signal, the spatial audio signal comprising at least one audio signal and spatial metadata associated with the at least one audio signal;
generate a mixing value based on the spatial metadata and a predefined parameter which imparts effects of a rendering of a multichannel audio signal having a multichannel configuration to a further multichannel audio signal having a further multichannel configuration on generated output signals, wherein the multichannel configuration is indicated by a loudspeaker configuration parameter; and
generate the output audio signals having the further multichannel configuration based on the mixing value and the spatial audio signal.

2. The apparatus as claimed in claim 1, wherein the apparatus caused to generate the mixing value based on the spatial metadata and the predefined parameter is caused to:
generate a direct sound value for each channel of the multichannel configuration based on a spatial sound direction parameter, a spatial sound energy ratio parameter and the multichannel configuration, wherein the spatial metadata comprises the spatial sound direction parameter and the spatial sound energy ratio parameter; and
generate an ambient sound value for each channel of the multichannel configuration based on the spatial sound energy ratio parameter and the multichannel configuration.

3. The apparatus as claimed in claim 2, wherein the apparatus caused to generate a direct sound value for each channel of the multichannel configuration based on the spatial sound direction parameter, the spatial sound energy ratio parameter and the multichannel configuration is caused to:
generate a panning gain value for each channel based on amplitude panning and the spatial sound direction parameter; and
generate the direct sound value for each channel by multiplying the panning gain value by the spatial sound energy ratio parameter.

4. The apparatus as claimed in claim 2, wherein the apparatus caused to generate the ambient sound value for each channel of the multichannel configuration based on the spatial sound energy ratio parameter and the multichannel configuration is caused to:
determine the ambient sound value for each channel as the ratio of one minus the spatial audio energy ratio parameter to the number of channels of the multichannel configuration.

5. The apparatus as claimed in claim 4, wherein the apparatus caused to generate the mixing value based on the spatial metadata and the predefined parameter which imparts the effects of the rendering of the multichannel audio signal having the multichannel configuration to the further multichannel audio signal having the further multichannel configuration on the generated output signals is caused to:
multiplying the direct sound value and the ambient sound value for each channel of the multichannel configuration with a corresponding channel gain, wherein the corresponding channel gain is derived, for each channel, from the predefined parameter.

6. The apparatus as claimed in claim 1, wherein the predefined parameter which imparts the effects of the rendering of the multichannel audio signal having the multichannel configuration to the further multichannel audio signal having the further multichannel configuration on the generated output signals comprises a predefined matrix whose components are gain terms derived for the mixing of a multichannel audio signal whose configuration is the multichannel configuration to the further multichannel audio signal whose configuration is the further multichannel configuration, wherein each column or row of the predefined matrix corresponds to a channel of the further multichannel audio signal.

7. The apparatus as claimed in claim 6, wherein the corresponding channel gain is determined by summing components of a corresponding column or row of the predefined matrix.

8. The apparatus as claimed in claim 1, wherein the predefined parameter which imparts the effect of the rendering of the multichannel audio signal having the multichannel configuration to the further multichannel audio signal having the further multichannel configuration on the generated output signals comprises a vector of channel gains, where each component of the vector of channel gains comprises a channel gain determined by summing terms of a column or a row of a predefined matrix, wherein the predefined matrix whose components are gain terms derived for the mixing of a multichannel audio signal whose configuration is the multichannel configuration to the further multichannel audio signal whose configuration is the further multichannel configuration, wherein each column or row of the predefined matrix corresponds to a channel of the further multichannel audio signal.

9. The apparatus as claimed in claim 8, wherein the corresponding channel gain is determined as a channel gain from the vector of channel gains.

10. The apparatus as claimed in claim 1, wherein the multichannel configuration is a 5.0 channel configuration and wherein the further channel configuration is a stereo channel.

11. The apparatus as claimed in claim 10, wherein the predefined parameter comprises a first column or row vector of the gain terms [1, 0, 0.7, 0.7, 0] and a second column vector or row of the gain terms [0, 1, 0.7, 0, 0.7].

12. The apparatus as claimed in claim 1, wherein the multichannel configuration is a 5.1 channel configuration and wherein the further channel configuration is a stereo channel.

13. The apparatus as claimed in claim 12, wherein the predefined parameter comprises a first column or row vector of the gain terms [1, 0, 0.7, 0.7, 0.7, 0] and a second column or row vector of the gain terms [0, 1, 0.7, 0.7, 0, 0.7].

14. The apparatus as claimed in claim 1, wherein the spatial audio energy ratio parameter is a direct to total energy ratio, and wherein the spatial audio direction parameter comprises an elevation value and an azimuth value.

15. A method comprising:
receiving a spatial audio signal, the spatial audio signal comprising at least one audio signal and spatial metadata associated with the at least one audio signal;
generating a mixing value based on the spatial metadata and a predefined parameter which imparts effects of a rendering of a multichannel audio signal having a multichannel configuration to a further multichannel audio signal having a further multichannel configuration on generated output signals, wherein the multichannel configuration is indicated by a loudspeaker configuration parameter; and
generating the output audio signals having the further multichannel configuration based on the mixing value and the spatial audio signal.

16. The method as claimed in claim 15, wherein generating the mixing value based on the spatial metadata and the predefined parameter comprises:
generating a direct sound value for each channel of the multichannel configuration based on a spatial sound direction parameter, a spatial sound energy ratio parameter and the multichannel configuration, wherein the spatial metadata comprises the spatial sound direction parameter and the spatial sound energy ratio parameter; and
generating an ambient sound value for each channel of the multichannel configuration based on the spatial sound energy ratio parameter and the multichannel configuration.

17. The method as claimed in claim 16, wherein generating a direct sound value for each channel of the multichannel configuration based on the spatial sound direction parameter, the spatial sound energy ratio parameter and the multichannel configuration comprises:
generating a panning gain value for each channel based on amplitude panning and the spatial sound direction parameter; and
generating the direct sound value for each channel by multiplying the panning gain value by the spatial sound energy ratio parameter.

18. The method as claimed in claim 16, wherein generating the ambient sound value for each channel of the multichannel configuration based on the spatial sound energy ratio parameter and the multichannel configuration comprises:
determining the ambient sound value for each channel as the ratio of one minus the spatial audio energy ratio parameter to the number of channels of the multichannel configuration.

19. The method as claimed in claim 18, wherein generating the mixing value based on the spatial metadata and the predefined parameter which imparts the effects of the rendering of the multichannel audio signal having the multichannel configuration to the further multichannel audio signal having the further multichannel configuration on the generated output signals comprises:
multiplying the direct sound value and the ambient sound value for each channel of the multichannel configuration with a corresponding channel gain, wherein the corresponding channel gain is derived, for each channel, from the predefined parameter.

20. The method as claimed in claim 15, wherein the predefined parameter which imparts the effects of the rendering of the multichannel audio signal having the multichannel configuration to the further multichannel audio signal having the further multichannel configuration on the generated output signals comprises a predefined matrix whose components are gain terms derived for the mixing of a multichannel audio signal whose configuration is the multichannel configuration to the further multichannel audio signal whose configuration is the further multichannel configuration, wherein each column or row of the predefined matrix corresponds to a channel of the further multichannel audio signal.

21-28. (canceled)
